(19) United States
(12) Patent Application Publication
(10) Pub. No.: US 2015/0294237 A1
(43) Pub. Date: Oct. 15, 2015

(54) SYSTEM AND METHOD FOR SIMULTANEOUSLY DISPLAYING NON-SCHEDULED AND SCHEDULED AIR TRAVEL SERVICES FOR BOOKING FLIGHTS

(71) Applicant: Gavin Stener, Dallas, TX (US)

(72) Inventor: Gavin Stener, Dallas, TX (US)

(21) Appl. No.: 14/728,782

(22) Filed: Jun. 2, 2015

Related U.S. Application Data
(63) Continuation of application No. 13/507,400, filed on Jun. 25, 2012.
Application No. 13/507,400 is a continuation of application No. 10/752,828, filed on Jan. 6, 2004, now abandoned.
Application No. 10/752,828 is a continuation of application No. 13/507,892, filed on Aug. 3, 2012, now abandoned.
Application No. 13/507,892 is a continuation of application No. 10/122,644, filed on Apr. 11, 2002, now Pat. No. 8,244,549.
Application No. 10/122,644 is a continuation of application No. 13/507,817, filed on Jul. 30, 2012.
Application No. 13/507,817 is a continuation of application No. 10/122,642, filed on Apr. 11, 2002, now abandoned.
(60) Provisional application No. 60/438,440, filed on Jan. 6, 2003.

(51) Int. Cl. G06Q 10/02; G06Q 10/10

(52) U.S. Cl. CPC G06Q 10/02; G06Q 10/1093

(57) ABSTRACT

A system and method for providing the ability to request scheduled and non-scheduled flight information and display the information on a user-interface has been developed. By displaying both the schedule and non-scheduled flight information, a simple comparison of both travel services can be made and a request for a flight for a traveler can be performed.

### RELATED APPLICATIONS

This application is (i) a continuation of U.S. application Ser. No. 13/507,400, filed Jun. 25, 2012, which is a continuation of U.S. application Ser. No. 10/752,828, filed Jan. 6, 2004, which claims the benefit of U.S. application Ser. No. 60/438,440, filed Jan. 6, 2003, and (ii) U.S. application Ser. No. 13/507,892, filed Aug. 3, 2012, which is a continuation of U.S. application Ser. No. 10/122,644, filed Apr. 11, 2002, which issued as U.S. Pat. No. 8,244,549 on Aug. 14, 2012, and (iii) also a continuation of U.S. application Ser. No. 13/507,817, filed Jul. 30, 2012, which is a continuation of U.S. application Ser. No. 10/122,642, filed Apr. 11, 2002, each of which is hereby incorporated herein by reference in their entirety.

### TECHNICAL FIELD OF THE INVENTION

The principles of the present invention are generally directed to combining information for non-scheduled and scheduled air travel services, and more particularly, but not by way of limitation, to enable a traveler to search for flight and other travel information based on entered time point(s) and receive flight information for both non-scheduled and scheduled air travel services for booking flights.

### DESCRIPTION OF RELATED ART

Traditional air travel services for travelers have included non-scheduled and scheduled air travel services. Scheduled air travel services relate to commercial airlines flying under a 121 flight certificate. Non-scheduled air travel services relate to privately owned, fractionally owned, or charter aircraft or air transport providers flying under a FAR Part 91, 121, or 135 flight certificate, for example. Scheduled and non-scheduled air travel services operate on different business models. Scheduled air travel services (e.g., commercial airlines) utilize a supply business model by scheduling flights based on forecasted travel times for travelers. After scheduling the flights, the commercial airlines publish the flight information in anticipation of travelers booking seats on the flights. The non-scheduled air travel services utilize a demand business model by allowing travelers (e.g., fractional owners of a private jet) to request an aircraft to fly at any desired time and between any locations.

Traditionally, the non-scheduled and scheduled air travel services are operated separately. Information associated with each air travel service is maintained separately and independently. For a traveler to determine how best to travel between locations by considering both the non-scheduled and scheduled air travel services, the traveler must contact both air travel services independently for flight availability and pricing.

In addition to travelers having to contact both non-scheduled and scheduled air travel services when making travel arrangements for a trip, travelers are left with the tedious task of having to determine each segment of the trip (i.e., door to door) and each mode of transportation. For example, in the case of a business traveler having a business meeting or event at 3:00 p.m. in a different city, the traveler needs to determine how to travel to the airport, which flight best conforms to the meeting time, how to travel from the airport to the meeting location, cost for each mode of transportation, etc. Making these travel arrangements can be time consuming as departure times and travel services need to be independently determined to conform each other and to the event.

### SUMMARY

To overcome the problem of travelers having to contact both scheduled and non-scheduled air travel services, a system and method for providing the ability to request scheduled and non-scheduled flight information and display the information on a user-interface has been developed. By displaying both the scheduled and non-scheduled flight information, a simple comparison of both travel services can be made and a request for a flight for a traveler can be performed.

Furthermore, to overcome the problem of travelers having to determine multiple modes of transportation to attend an event at a specific time, the principles of the present invention provide for a reference time or “anchor” time associated with the event and unrelated to a transportation service from which to plan a trip to be set. Based on the reference time, multiple modes of transportation may be determined from an origination location to a destination location. A starting time of the trip based on the reference time and transportation times may be determined. A travel itinerary including the starting time of the trip and the modes of transportation may be generated.

### BRIEF DESCRIPTION OF THE DRAWINGS

FIG. 1A is a block diagram describing an exemplary communication relationship between a non-scheduled air travel provider and scheduled air travel provider and scheduled air travel provider;

FIG. 1B is a block diagram describing the communication relationship of FIG. 1A with the addition of scheduled air travel consolidation and booking services(s);

FIG. 1C is a block diagram describing the communication relationship of FIGS. 1A and 1B with the addition of an air travel management service;

FIG. 1D is a block diagram describing the communication relationship of FIG. 1B showing demand management infrastructure and a conventional global distribution system;

FIG. 2 is a block diagram of an exemplary system for providing communications described in FIGS. 1A-1D;

FIG. 3A is a flow diagram that describes an exemplary process for consolidating non-scheduled and scheduled flight information;

FIG. 3B is a more detailed flow diagram that describes an exemplary process for consolidating non-scheduled and scheduled flight information;

FIG. 4 is an embodiment of an exemplary graphical user interface (GUI) for booking a flight;

FIG. 5 is a flow diagram for determining travel services based on reference time information;

FIG. 6 is a flow diagram of an exemplary process for computing potential direct and indirect costs for travel services provided to travelers;

FIG. 7 is an exemplary timeline representative of a travel itinerary for a traveler based on a reference time; and

FIG. 8 is an exemplary display for displaying quotes and flight options for flights, including options for both non-scheduled and scheduled flight.

### DETAILED DESCRIPTION OF THE EXEMPLARY EMBODIMENTS

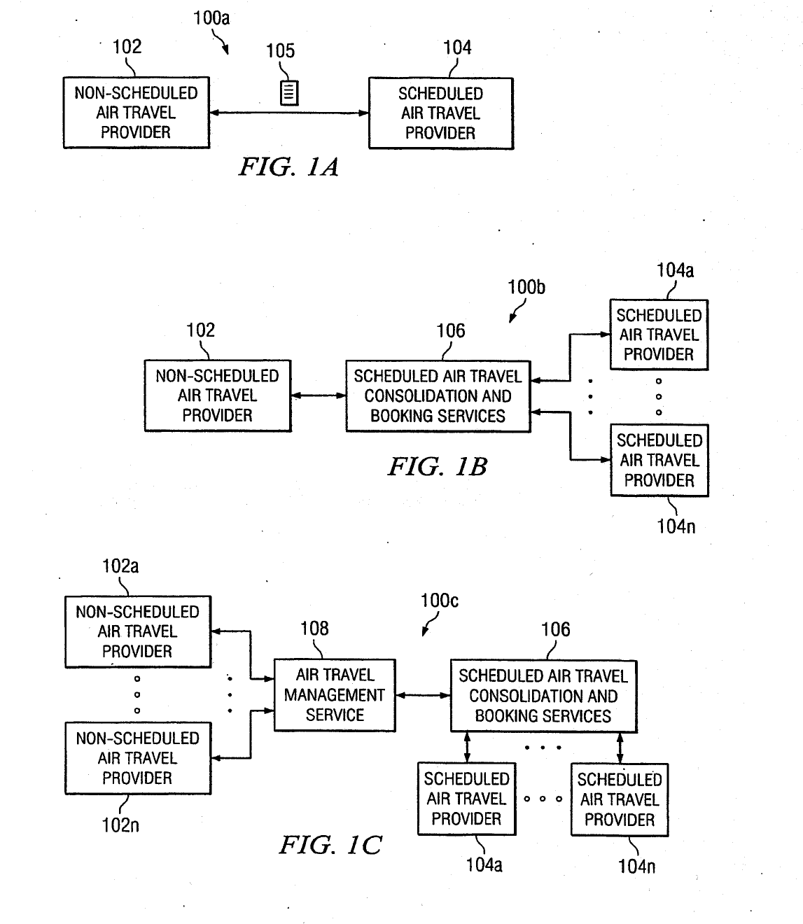

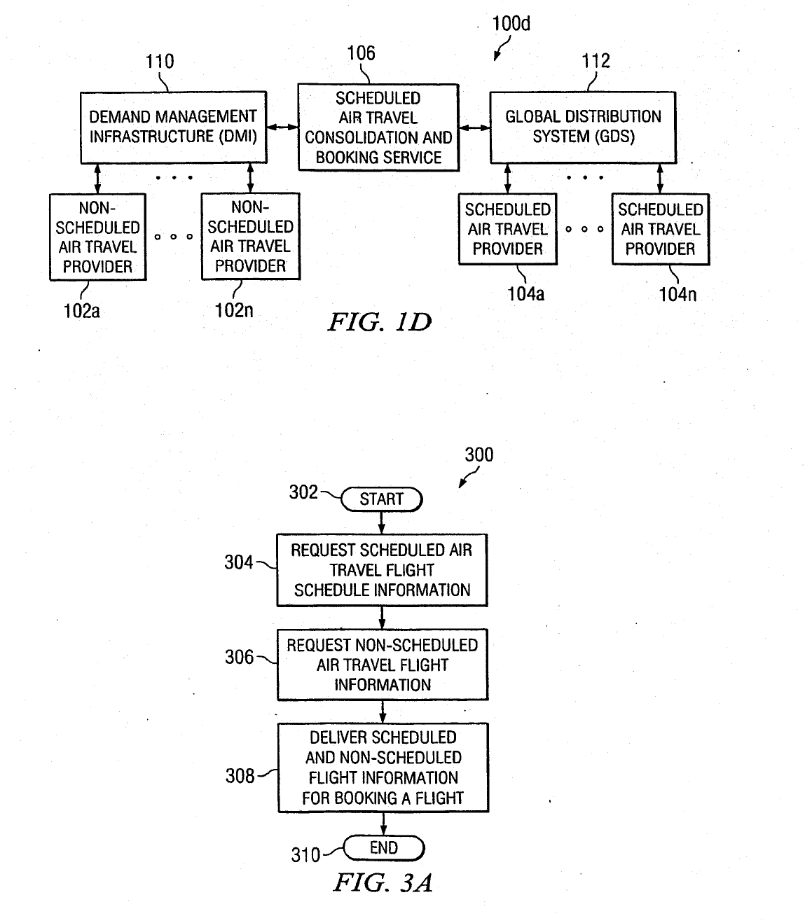

FIG. 1A is a block diagram 100a describing an exemplary communication relationship between a non-scheduled air travel provider 102 and scheduled air travel provider 104. The non-scheduled air travel provider 102 and scheduled air travel provider 104 may be separate companies or be part of the same company. The communication may include information 105 associated with flight times, availability, and price associated with flight options. It should be understood that at least a portion of the information maintained and provided by the non-scheduled air travel provider 102 and the scheduled air travel provider 104 is different as the non-scheduled air travel provider 102 does not schedule flights as does a commercial carrier, but rather books flights based on non-forecasted demand and provides a probability that a flight will be flown at a particular time. Accordingly, information may be maintained and shared by the air travel providers 102 and 104. Additional information associated with scheduled and non-scheduled air travel providers may be found in co-pending U.S. patent application Ser. Nos. 10/122,642 and 10/122,644, both filed Apr. 11, 2002, which are incorporated herein by reference in their entirety.

FIG. 1B is a block diagram 100b that describes the communication relationship of FIG. 1A with the addition of scheduled air travel consolidation and booking service(s) 106. The scheduled air travel consolidation and booking service(s) 106 may include an air travel service provider, such as Travelocity™ and Expedia™, that consolidates flight bookings on behalf of scheduled air travel service providers 104a-104n (collectively 104). As indicated, the non-scheduled air travel provider 102 and scheduled air travel consolidation and booking services 106 may communicate information so that the non-scheduled air travel provider 102 may provide information to the scheduled air travel consolidation and booking services 106. The flight information from the non-scheduled air travel provider 102 may be provided to travelers as an alternate flight option to scheduled air travel provided by the scheduled air travel providers 104.

FIG. 1C is a block diagram 100c that describes the communication relationship of FIGS. 1A and 1B with the addition of an air travel management service 108 that may receive information from one or more non-scheduled air travel providers 102a-102n (collectively 102). The air travel management service 108 may communicate and/or share information related to the flight options of the non-scheduled air travel providers 102 with the scheduled air travel consolidation and booking services 106. The information that is shared may be provided to potential travelers who are interested in booking a flight with either a scheduled air travel provider 104 or non-scheduled travel providers 102. In another embodiment (not shown), the air travel management service 108 may alternatively communicate directly with the scheduled air travel providers 104. Any other combination of communication between parties associated with the non-scheduled and scheduled air travel providers 102 and 104 or their representatives may be performed according to the principles of the present invention.

FIG. 1D is a block diagram 100 describing the communication relationship of FIG. 1B in more detail showing demand management infrastructure (DMI) 110 and a conventional global distribution system (GDS) 112. As understood in the art, the global distribution system 112 is a repository that operates as a clearinghouse for seat inventory and capacity of scheduled flights. Companies, such as Sabre™, Worldspan™, and Galileo™, are examples of companies that operate global distribution systems that the scheduled air travel consolidation and booking service 106 may utilize to offer seat inventory to travelers. Travel agencies or other proxy services (not shown) may also access the global distribution system 112.

The demand management infrastructure 110 may operate as a repository or database. In essence, the demand management infrastructure operates as an aggregation or pooling of demand from members of a traveling community for the purposes of an air travel service provider delivering transport on demand for the traveling community absent of any predetermined inventory of capacity established by the air travel service provider prior to actual demand being known. Non-scheduled flights that are booked by air travel service providers 102 based on the demand at particular times may be stored in the demand management infrastructure 110 and have a probability of flight associated with each booked flight. Travelers who are interested in flying on a non-scheduled flight may view the availability of flights and probability of a non-scheduled flight at the time of request. Because both demand and velocity of demand may change over time, the non-scheduled flights are generally assigned a probability of flying. The probability may be determined based on a number of factors, including demand, velocity of demand, aircraft capacity, time until flight, scheduled air travel provider bias and cost to fly, and/or other factors associated with flying non-scheduled flights. Such other factors may include freight or requirements to move assets (e.g., airplanes). Because the information stored by the demand management infrastructure 110 includes information related to non-scheduled flights, such as load capacity, demand, probability of flight, or other end-user demand related information, different parameters may be utilized to communicate with the demand management infrastructure 110 than the global distribution system 112 as understood in the art.

Although the demand management infrastructure 110 and global distribution system 112 are shown as two different repositories, the information of each may be formed in a single repository. Other configurations of the demand management infrastructure 110 and global distribution system 112 may be utilized in accordance with the principles of the present invention. As a result, by utilizing the principles of the present invention, a non-scheduled air travel provider 102 or affiliates thereof may access information stored in the global distribution system 112 and a scheduled air travel provider 104 or affiliates thereof (e.g., travel agents) may access information stored in the demand management infrastructure 110.

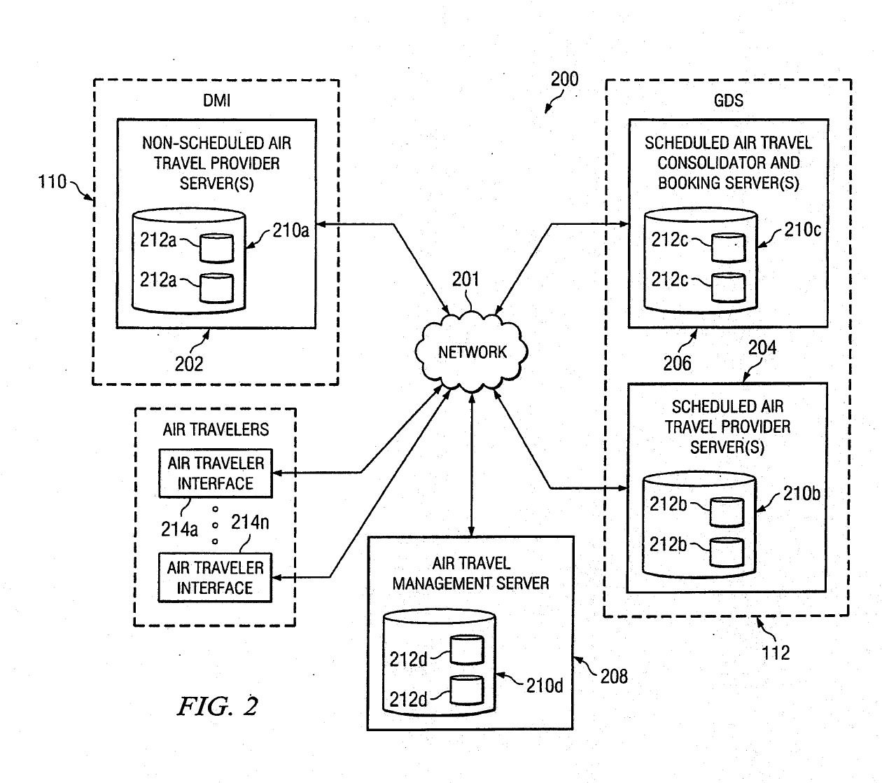

FIG. 2 is a block diagram of an exemplary system 200 for providing communications described in FIGS. 1A-1D. The system 200 includes computing systems, such as servers, to manage and communicate non-scheduled and scheduled flight information via a network 201. In one embodiment, the network is the Internet. Other networks, such as telecommunications, satellite, local area networks (LAN), and wide area networks (WAN) may be utilized for the communication media between the computing systems. The communications occurring between the computing systems may be performed according to the block diagrams of FIGS. 1A-1D.

As shown, a non-scheduled air travel provider server 202, scheduled air travel provider server 204, scheduled air travel consolidator and booking server 206, and air travel management server 208 may be utilized to communicate information associated with the air travel services there between. Each of the servers 202-208 include or are in communication with storage devices 210a-210d that store databases 212a-212d containing information associated with each party. The term database is meant to signify a repository of data, whether operated by a computer program, simply maintained as a datafile containing raw data, or otherwise. The databases 212a stored at the server 202 may contain flight information associated with the non-scheduled air travel provider 102 and the databases 212b stored at the server 204 may contain flight information associated with the scheduled air travel provider 104. The information contained in the databases 212a and 212b may be accessed (e.g., queried) and communicated to the databases 212c and 212d to enable the scheduled air travel consolidation and booking services 106 and air travel management service 108 to display, quote, and book non-scheduled and scheduled flight options for air travelers. As indicated by dashed lines, and consistent with FIG. 1D, the non-scheduled air travel provider server 202 may operate as or in conjunction with a demand management infrastructure 110 and the scheduled air travel consolidator booking server 206 and scheduled air travel provider server 204 may operate as or in conjunction with a global distribution system 112.

In operation, air travelers may utilize a user interface or air traveler interface 214a-214n (collectively 214) to communicate with any of the servers 202-208 associated with the parties of FIG. 1C. The air traveler interfaces 214 may include personal computers, wireless devices, such as mobile telephones, personal digital assistants (PDAs), pagers (e.g., 2-way pagers), etc. In one embodiment, an air traveler interface 214 may include positioning capability, such as a global positioning system (GPS), to determine location information and communicate the location information to the server communicating with the air traveler interface 214. The air traveler interface 214 may include security mechanisms, such as biometric readers, to enable the traveler to access the information stored on the servers that have security measures to protect unauthorized access to personal information of the travelers. In addition, a computing system (not shown) with which the air traveler interface 214 communicates may determine positioning information by using triangulation or other techniques for determining position of the air traveler interface 214 as understood in the art. By knowing the location of the traveler, flight information communicated to the traveler may be filtered to include flights or other information related to that location.

The information being stored in the databases 212 may include flight information and/or traveler information. The consolidator server 206 or air travel management server 208 may communicate directly with the air traveler interface 214 of the traveler to assist in booking a flight. In response to the traveler requesting flight information, depending upon the communication arrangement, the consolidator server 206 or air travel management server 208 may query the non-scheduled air travel provider server(s) 202 and/or the scheduled air travel provider server(s) 204 to request flight information associated with the request of the traveler. It should be understood that the information from the scheduled air travel provider server 204 may include scheduled flights, seat availability, and prices for the scheduled flights, whereas the information from the non-scheduled air travel provider server 202 may include the availability of airplanes, available capacity, probability of flight departures, and prices for allocating an airplane and/or capacity on a previously allocated airplane with excess capacity. The information provided to the consolidator server 206 and/or air travel management server 208 may be communicated to the air traveler interface 214 to provide comparative information for the traveler to substantially simultaneously compare travel options, including non-scheduled and scheduled flight options, for booking purposes.

In accordance with the principles of the present invention, a user-interface (not shown), such as a computer or other electronic interface, that is operated by a proxy for the traveler may be utilized to communicate with one or more of the servers 202, 204, and 206 via the network 201. For example, rather than the traveler performing the communications directly, a secretary, spouse, or other person may book the flight for the traveler. Still yet, a user-interface operated by an agent (e.g., travel agent) may be utilized to communicate with one or more of the servers 202, 204, and 206 to book a flight for the traveler. The user-interface that is utilized by the traveler, proxy, or agent may provide the same or different information depending upon the operator of the user-interface. For example, an agent may have access to different or more detailed information than a traveler. To protect access to the information in the global distribution system 112 or demand management infrastructure, a password or more secure authentication system as described in copending U.S. Provisional Patent Application 60/469,072, filed May 7, 2003, which is incorporated herein by reference in its entirety, may be utilized.

TABLE 1 is an exemplary database including information maintained by the scheduled air travel provider 104. As shown, the information may include date, from/to locations, scheduled flight numbers, scheduled departing and arrival times, scheduled departing arrival gates. Accordingly, the information provided includes scheduled flight information and other related information may singularly be maintained.

TABLE 2 is an exemplary database including information maintained by the non-scheduled air travel provider 102. As shown, the information may include a sequential flight number based on the aircraft being allocated to meet demand, date, departure and arrival locations, type of plane, capacity of aircraft, range of aircraft, booked capacity, hours available for the aircraft, departing and arrival times, and confirmation percentage (i.e., the probability based on demand profiles that the tentatively allocated flight is to be flown).

TABLE 1
SCHEDULED AIR TRAVEL PROVIDER FLIGHT SCHEDULES

| | | | Flight | | | Departure | Arrival |
|---|---|---|---|---|---|---|---|
| Date | From | To | Number | Departs | Arrives | Gate | Gate |
| Jan. 12, 2003 | Dallas | Newark | 622 | 6:40AM | 12:40PM | C17 | A23 |
| Jan. 12, 2003 | Dallas | Newark | 704 | 7:28AM | 1:10PM | C19 | A21 |
| . . . | | | . . . | | | | |

TABLE 2
NON-SCHEDULED AIR TRAVEL PROVIDER BOOKED AIRCRAFT

| Flight | | | | | | Range | | Hours | | | |
|---|---|---|---|---|---|---|---|---|---|---|---|
| Number | Date | From | To | Plane Type | Capacity | (mi) | Booked | Available | Departs | Arrives | Confirm |
| 1 | Jan. 12, 2003 | Dallas | Newark | Hawker 800 | 8 | 2400 | 2 | 12 | 6:45AM | 11:58AM | 100% |
| 2 | Jan. 12, 2003 | Dallas | Newark | Hawker 800 | 8 | 2400 | 3 | 8 | 7:00AM | 12:15 PM | 50% |
| . . . | | | | | . . . | | | | | | |

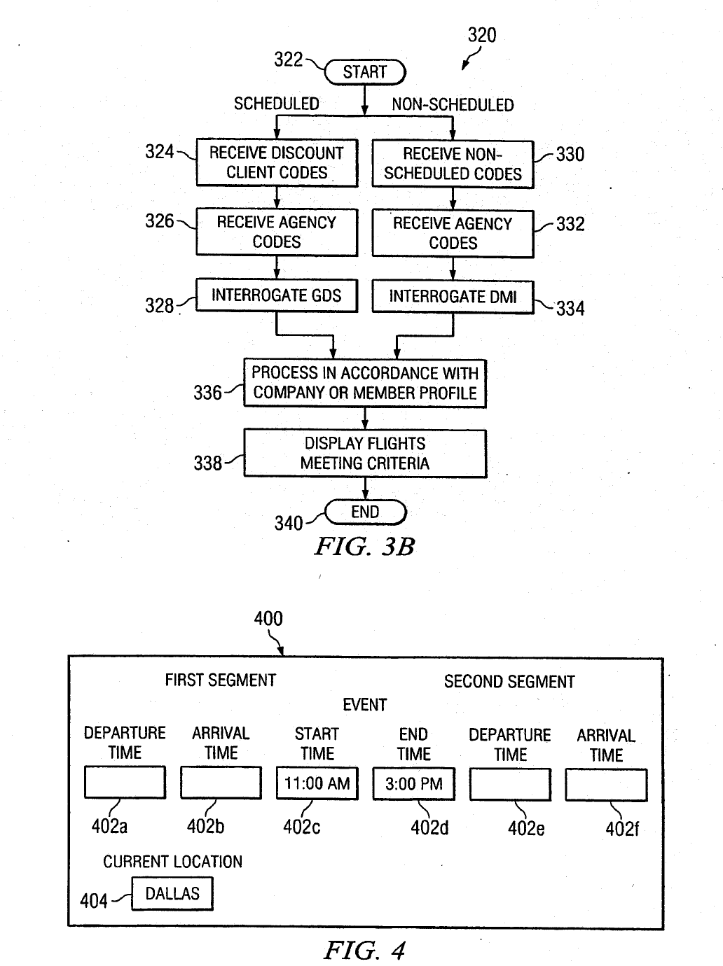

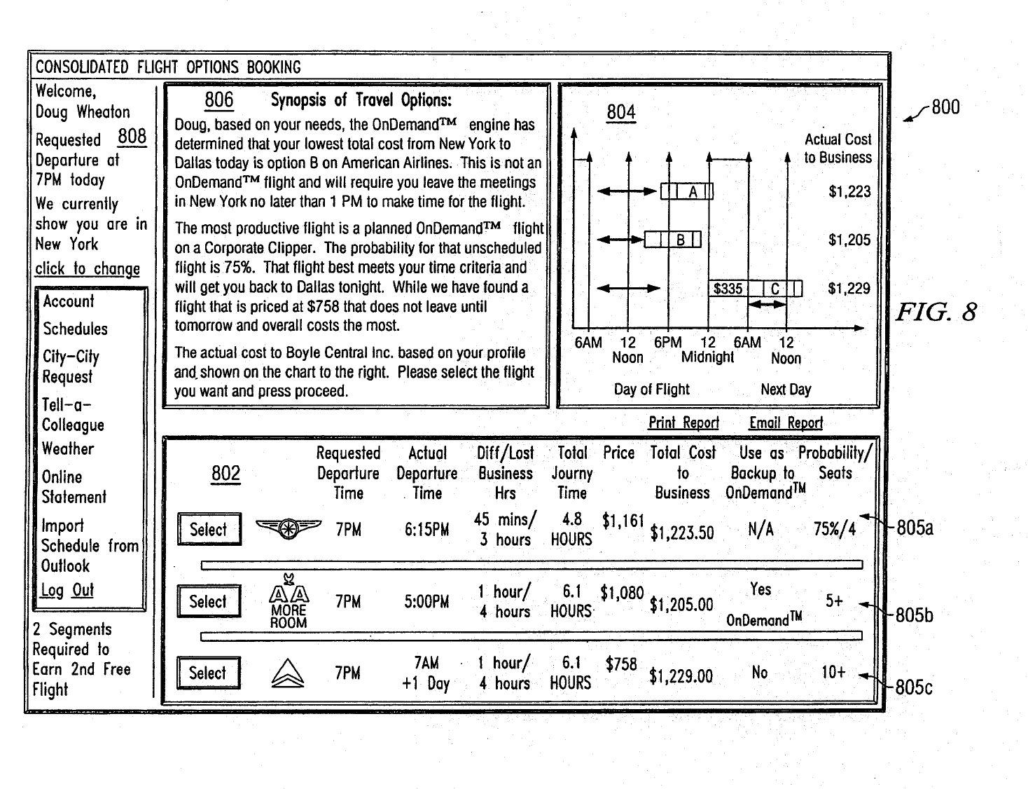

FIG. 3A is a flow diagram that describes an exemplary process 300 for consolidating non-scheduled and scheduled flight information. The consolidation process 300 starts at step 302. At step 304, the scheduled air travel flight schedule information is requested. In one embodiment, the information stored in the database 212b via the scheduled air travel provider server 204 is requested via the network 201 utilizing a search or look-up query protocol as understood in the art. At step 306, the non-scheduled air travel flight information is requested. The information may be requested in a similar manner to that of the step 304. The non-scheduled and scheduled flight information may be consolidated and delivered for display to book a flight at step 308 (see, for example, FIG. 8, display portion 802). In consolidating the information, the non-scheduled and scheduled flight information may be stored in a database 210c, stored in volatile memory to be communicated without storage in a more permanent database, or simply delivered to a user-interface for display thereon. The consolidated information may be communicated to the scheduled air travel consolidation and booking services 106, air travel management service 108, proxy, agent, or directly to a traveler. The process ends at step 310.

FIG. 3B is a more detailed flow diagram that describes an exemplary process 320 for consolidating non-scheduled and scheduled flight information. The process starts at step 322, at step 324, a discount client code may be received. A discount client code is a code assigned to an organization, such as a company, that prearranges discount fares or rates for purchasing airline tickets with a scheduled air travel provider. If a travel agency is purchasing a ticket for a client, then an agency code associated with the agency may be received at step 326. A global distribution system may be interrogated for flight availability between locations and at a desired time and/or date at step 328.

If a traveler is interested in flying on a non-scheduled flight, then a non-scheduled code may be received at step 330. The non-scheduled code may be associated with an organization or individual traveler to provide discounts or to simply identify a user. Although shown in parallel, step 330 may be performed before, after, or independent of steps 324-328. If an agency is involved in booking or requesting a flight, then an agency code may be received at step 332. The demand management infrastructure may be interrogated at step 334 for non-scheduled flight availability or to request a flight between locations and on certain dates and/or times.

At step 336, the information received by interrogating the global distribution system 112 and demand management infrastructure may be processed in accordance with a company and/or member profile. The company and/or member profile may designate maximum prices, flight time limitations, flight layover limitations, etc. The scheduled and non-scheduled flights that meet criteria of the company and/or member profiles may be displayed at step 338 for selection or informational purposes. The process ends at step 340.

FIG. 4 is an exemplary embodiment of a graphical user interface (GUI) 400 for booking a flight. The GUI 400 may include a number of different time entry fields 402a-402f (collectively 402). The time entry fields 402 may be associated with departure and arrival times of a first segment, start and end times of an event, and departure and arrival times of a second segment. An event is to be considered something other than a time of departure or arrival of a mode or method of transportation. For example, the event may be associated with a meeting, party, or any other event that the traveler has scheduled at an origination or destination location. The traveler may selectively enter time information associated with one or more of the time entry fields 402. Although the event start and end times are both shown in time entry fields 402c and 402d, the principles of the present invention may be operated by defining or specifying both, one, or none. As shown, the GUI 400 may include current location 404 or other data related to the current location of the traveler. It should be understood that while time entry fields are shown on the GUI 400 for entry, other parameter fields may alternatively and/or additionally be provided for entry by the traveler. Such other parameter fields may include distance, desired route or waypoint, travel accommodations, etc. By being able to enter desired times for other than departure time from either the origination or destination locations, the traveler is able to use different criteria for reference or “anchor” times to enable the system to generate other travel times according to the principles of the present invention. Generation of other travel times may include both forward and backward schedule relative to the anchor time or event to generate and provide different and/or additional modes of transportation travel options (e.g., taxi, limousine, train services) to enable a traveler to book transportation services from doorstep to doorstep. In one embodiment, in response to a nonscheduled flight being requested, because the non-scheduled flight may have a probability less than 100 percent of being flown, a reservation on a scheduled flight may be established for a traveler.

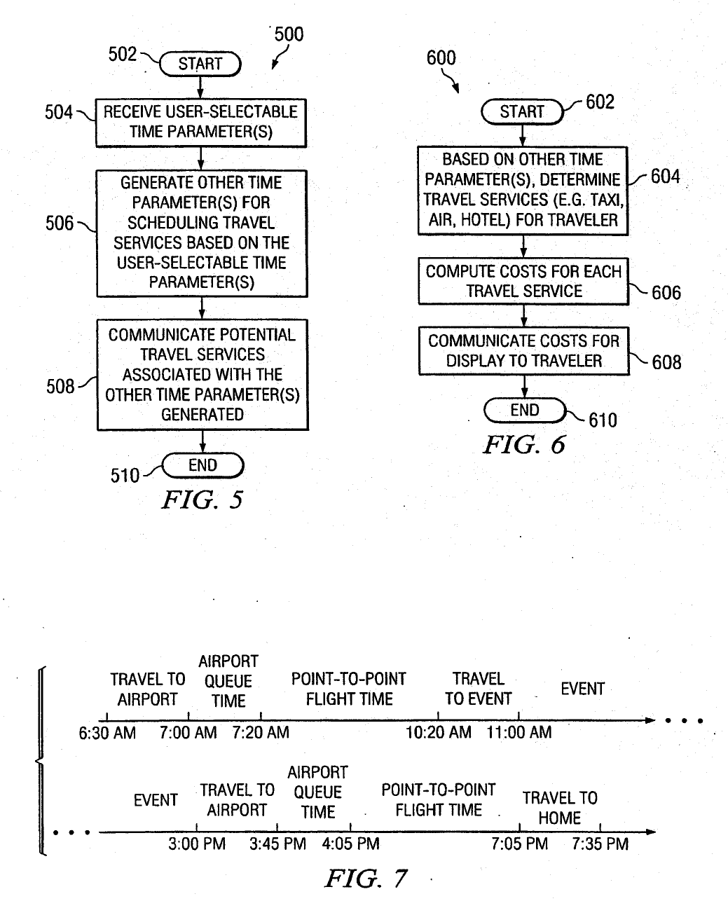

FIG. 5 is a flow diagram of an exemplary process 500 for generating travel services based on reference time information. The process starts at step 502. At step 504, one or more user-selectable time parameter or reference time is received. Based on the user-selectable time parameter(s) received, other time parameter(s) for scheduling travel services may be generated at step 506. The other time parameter(s) may include time for each segment of a trip, including time from the origination location to the departure airport, queuing time at the airport prior to flight, time from the destination airport to final destination, etc.

The travel services include multiple modes of transportation, including automobile, train, helicopter, etc. Based on the reference time(s), one or more modes of transportation may be determined to transport a traveler from an origination location to a destination location and provided in the form of an itinerary showing a starting time and/or ending time of a trip depending upon which end of the trip for selection and/or the reference time is associated. A travel itinerary is a route or proposed route of a trip. In the case of setting the reference time to an event at a destination location, each of the segments of the trip extending to the origination location may be determined, including mode of transportation and time of travel. The traveler is thereby notified when to leave the origination location based on the estimated time of travel for each segment. This setting of the reference time at the destination location triggers a reverse planning operation or scheduling. In the case of setting the reference time to an event at an origination location, each of the segments of the trip extending to the destination location may be determined, including mode of transportation and time of travel. The traveler is thereby notified when the time of arrival at the destination location based on the estimated time of travel for each segment. This setting of the reference time at the origination location triggers a forward planning or scheduling operation.

A variety of travel options for traveling along each segment along a trip may be provided for selection. For example, to travel along one segment of a trip (e.g., office to airport), taxi service, limousine service, train service, bus service, or self-drive may be options provided for selection, where each service may include an associated time and cost. The options may include travel from the origination location, for example, to multiple local airports for flying non-scheduled and scheduled flights. In making determination of times for each mode of transportation, databases or repositories associated with each mode of transportation may be accessed to determine schedule, time, and price, for example. Other intelligent methodologies may be employed, including mapping algorithms, time-of-day traffic considerations, weather forecast predictions, or other methods to provide more accurate estimates of time and cost to travel on one or more modes of transportation between locations. By utilizing the principles of the present invention, travel time and costs may be optimized for a traveler in response to an anchor time, origination location, and destination location being provided.

At step 508, the potential travel services associated with the other generated time parameter(s) may be communicated. In one embodiment, the communication is made by the air travel management service 108 (FIG. 1C) to the scheduled air travel consolidation and booking services 106 (FIG. 1B) or directly to the traveler via a user-interface. Alternatively, the communication is made to a proxy or agent via a user-interface requesting information for the traveler. The communication may provide a visual or aural notification. The process ends at step 510.

FIG. 6 is an exemplary flow diagram 600 of an exemplary process for computing potential direct and indirect costs for travel services provided to travelers. The process starts at step 602. At step 604, travel services (e.g., taxi, air, hotel, etc.) may be determined based on other time parameter(s) (see, FIG. 5, step 506) for the traveler. At step 606, costs for each travel service may be computed, where travel services include transportation services (e.g., taxi, plane, limousine, etc.) and non-transportation services (e.g., hotel). At step 608, the costs may be communicated for display to the traveler. It should be understood that the costs may be communicated via one or more travel service before reaching the traveler. Also, a total cost of traveling may be computed and communicated to the traveler. In addition to the transportation and non-transportation costs, the total costs may include salary costs (i.e., potential loss of productivity based on an hourly rate, if available), personal time costs, miscellaneous expenses (e.g., meals), and other costs generally considered as a cost of doing business. The costs may be displayed for the traveler (see, for example, FIG. 8, display portions 802 and 804). The times and costs may be represented peripherally, alphanumerically, or as a combination.

FIG. 7 is an exemplary timeline 700 representative of a travel itinerary for the traveler based on a reference time. The timeline 700 may be generated automatically or semi-automatically as described by the processes of FIGS. 5 and 6 to generate and schedule the travel services for the traveler. As shown, the timeline 700 includes times to travel from an origination location to a destination location via a number of intermediary locations. The travel times include travel from a traveler's home or office to the departure airport, airport queue time, point-to-point flight time, travel from the arrival airport to an event, event time, travel back to the arrival airport, airport queue time, point-to-point flight time, and travel time to the home of the traveler. Other and/or different travel information that constructs the overall travel profile or itinerary of the traveler and used in accordance with the principles of the present invention may be displayed on one or more timelines, booking options (e.g., quotes), and/or schedule profiles.

FIG. 8 is an exemplary display 800 for displaying quotes and flight options for flights including both non-scheduled and scheduled flight options. The display may include multiple display portions, including display portions 802, 804, and 806. The display may be accessed by the traveler, proxy, and/or booking agent. Although the display 800 is embodied as a GUI, it should be understood that the information may alternatively be displayed on a text-based display (e.g., tabular format) to comply with legacy-type displays, such as those used by travel agents and ticketing agents.

In display portion 802, flight options, including price quotes, may be provided to select based on time parameter(s) entered (see, for example, FIG. 4). Display portion 804 may include a different view that displays a complete travel schedule for the traveler based on the time parameter(s) entered to provide a comparison between flight options. The flight options may include non-scheduled 805a and scheduled 805b and 805c flight options. Based on the complete travel schedule generated, total direct and incidental costs may be computed and displayed. It should be understood that a display for selection of travel arrangements or final costs may be graphical or text-based.

For example, as shown in display portion 804, for a one-way trip, non-scheduled flight option A (805a) has a total travel cost of $1,223 for the traveler and allows the traveler a full work day (approximately eight hours) at the destination while still achieving the traveler objective of returning home that same day. Scheduled flight option B (805b) requires that the traveler leave earlier (approximately 1:00 pm) in order to return home that day and costs $1,205. Flight option C (805c) is based on a discount ticket from a scheduled flight provider. However, because of scheduling limitations of the discount ticket, the traveler is required to incur costs for overnight accommodations and other related costs and to impact the ability of the traveler from returning home that same day. Overall, the non-scheduled flight option A (805a) is approximately the same cost as the scheduled flight options, but allows the business traveler more time to work, thereby increasing productivity of the business traveler.

In addition to display portions 802 and 804, display portion 806 may include a synopsis or natural language description of the flight options being proposed based on the time parameters entered or possible flight options selected. Further, other relevant information, such as current location 808 of the traveler, may be displayed on the display 800. Other information associated with the traveler, such as account balance, current miles flown, further may be simultaneously displayed or accessible on the display 800.

The innovative concepts described in the present application can be modified and varied over a wide rage of applications. Accordingly, the scope of patented subject matter should not be limited to any of the specific exemplary teachings discussed, but is instead defined by the following claims.

What is claimed is:

1. A method of preparing a booking report that displays calculated travel information for multiple types of proposed travel trips, said method comprising:
providing a coordination and management computer system that has a computer processor and a memory for operating a coordination and management computer program, said coordination and management computer system having one or more input/output terminals capable of receiving traveler requests and coupling the coordination and management computer to a plurality of different transportation service provider computer systems, said plurality of different transportation systems including at least one scheduled supply-based air transportation service provider systems, at least one non-scheduled demand-based air transportation service provider systems, and at least one ground transportation service provider systems;
receiving a travel request at the input/output terminal of the coordination and management computer system specifying a place of departure, a time of departure, and a place of arrival,
processing the travel request at the coordination and management computer system, said processing of said travel request by obtaining travel information from said plurality of different transportation service providers, including at least one scheduled supply-based air transportation service provider systems, at least one non-scheduled demand-based air transportation service provider systems, and at least one ground transportation service provider systems;
analyzing at the coordination and management computer system the best match of available travel options provided by the different transportation service providers to the time and place of departure and a place of arrival information submitted in the a traveler's request from the available options provided by the plurality of different transportation service providers;
generating a consolidated comparative travel booking information report that provides information of available travel options inclusive of costs and travel times of different modes of travel, likely number of available seats on scheduled flight options, and probability that any unscheduled flight options will be flown, said modes including scheduled supply-based air travel options, non-scheduled demand-based air travel options, a cost calculation including actual travel expense costs as well as non-expense costs incurred by the traveler, and said available travel options including a percent probability rating that one or more travel options will not occur; and,
transmitting said consolidated comparative travel booking information report from the coordination and management computer, said report simultaneously providing both proposed scheduled and non-scheduled flight information for the traveler on desired travel segments selected from the traveler request as well as simultaneously providing ground transportation for each proposed flight option shown on the report.

2. The method according to claim 1, wherein said booking report contains scheduled and non-scheduled flight information.

3. The method according to claim 1, wherein said booking report displays the scheduled and non-scheduled flight information on a user-interface.

4. The method according to claim 3, wherein the displaying of the scheduled and non-scheduled flight information includes displaying at least one of the scheduled and at least one non-scheduled flight information.

5. The method according to claim 1, further comprising:
receiving a subsequent booking request from the traveler related to one of the displayed travel options.

6. The method according to claim 1 further comprising the step of:
reserving a ticket on a scheduled flight in response to a request for potential service on a non-scheduled flight.

7. The method according to claim 1, further comprising the step of:
communicating the scheduled and non-scheduled flight information via a second user-interface.

8. A system for preparing a booking report that displays calculated travel information for multiple types of proposed travel trips, comprising:
a coordination and management computer system having a computer processor and a memory for operating a coordination and management computer program, said coordination and management computer system having one or more input/output terminals capable of receiving traveler requests and coupling the coordination and management computer to a plurality of different transportation service provider computer systems, said plurality of different transportation systems including at least one scheduled supply-based air transportation service provider systems, at least one non-scheduled demand-based air transportation service provider systems, and at least one ground transportation service provider systems;
said input/output terminal of the coordination and management computer system operable to receive a travel request communication that specifies a place of departure, time of departure, and a place of arrival,
the travel request being processed by the coordination and management computer system, including the system obtaining travel information said plurality of different transportation service providers, including at least one scheduled supply-based air transportation service provider systems, at least one non-scheduled demand-based air transportation service provider systems, and at least one ground transportation service provider systems;
the coordination and management computer system conducting a comparative analysis of the best match of available travel options provided by said plurality of different transportation service provider to the time and place of departure and a place of arrival information submitted in the traveler's request from the available options provided by the plurality of different transportation service providers;
said coordination and management computer system preparing a comparative travel booking information report that provides information of available travel options inclusive of costs and travel times of different modes of travel, likely number of available seats on scheduled flight options, and probability that any unscheduled flight options will be flown, said modes including scheduled supply-based air travel options, non-scheduled demand-based air travel options, a cost calculation including actual travel expense costs as well as non-expense costs incurred by traveler, and said available travel options including a percent probability rating that one or more travel options will not occur,
transmitting said consolidated comparative travel booking information report from the coordination and management computer, said report simultaneously providing both proposed scheduled and non-scheduled flight information for the traveler on desired travel segments selected from the traveler request as well as simultaneously providing ground transportation for each proposed flight option shown on the report.

9. The system according to claim 8, wherein said booking report contains scheduled and non-scheduled flight information.

10. The system according to claim 8, wherein said booking report displays the scheduled and non-scheduled flight information on a user-interface.

11. The system according to claim 10, wherein the displaying of the scheduled and non-scheduled flight information includes displaying at least one of the scheduled and at least one non-scheduled flight information.

12. The system according to claim 8, further comprising:
receiving a subsequent booking request from the traveler related to one of the displayed travel options.

13. The system according to claim 8 further comprising:
reserving a ticket on a scheduled flight in response to a request for potential service on a non-scheduled flight.

14. The system according to claim 8, further comprising:
communicating the scheduled and non-scheduled flight information via a second user-interface.

15. A method of reserving a principal back-up flight from multiple proposed travel options, said method comprising:
providing a coordination and management computer system that has a computer processor and a memory for operating a coordination and management computer program, said coordination and management computer system having one or more input/output terminals capable of receiving traveler requests and coupling the coordination and management computer to a plurality of different transportation service provider computer systems, said plurality of different transportation systems including at least one scheduled supply-based air transportation service provider systems, at least one non-scheduled demand-based air transportation service provider systems, and at least one ground transportation service provider systems;
receiving a travel request at the input/output terminal of the coordination and management computer system specify a place of departure, time of departure, and a place of arrival,
processing the travel request at the coordination and management computer system, said processing of said travel request by obtaining travel information from said plurality of different transportation service providers, including at least one scheduled supply-based air transportation service provider systems, at least one non-scheduled demand-based air transportation service provider systems, and at least one ground transportation service provider systems;
analyzing at the coordination and management computer system the best match of available travel options provided by the different transportation service providers to the time and place of departure and a place of arrival information submitted in the traveler's request from the available options provided by the plurality of different transportation service providers;
generating a consolidated comparative travel booking information report that provides information of available travel options inclusive of costs and travel times of different modes of travel, likely number of available seats on scheduled flight options, and probability that any unscheduled flight options will be flown, said modes including scheduled supply-based air travel options, non-scheduled demand-based air travel options, a cost calculation including actual travel expense costs as well as non-expense costs incurred by traveler, and said available travel options including a percent probability rating that one or more travel options will not occur,
transmitting said consolidated comparative travel booking information report from the coordination and management computer, said report simultaneously providing both proposed scheduled and non-scheduled flight information for the traveler on desired travel segments selected from the traveler request as well as simultaneously providing ground transportation for each proposed flight option shown on the report, and,
booking a principal flight on a previously non-scheduled flight in response to the receipt of booking information report; and
booking a back-up flight on a scheduled flight in response to the receipt of the booking information report.

16. The method according to claim 15, wherein said booking report contains scheduled and non-scheduled flight information.

17. The method according to claim 15, wherein said booking report displays the scheduled and non-scheduled flight information on a user-interface.

18. The method according to claim 17, wherein the displaying of the scheduled and non-scheduled flight information includes displaying at least one of the scheduled and at least one non-scheduled flight information.

19. The method according to claim 15, further comprising:
receiving a subsequent booking request from the traveler related to one of the displayed travel options.

20. The method according to claim 15 further comprising the step of:
reserving a ticket on a scheduled flight in response to a request for potential service on a non-scheduled flight.

21. The method according to claim 15, further comprising the step of:
communicating the scheduled and non-scheduled flight information via a second user-interface.

22. The method according to claim 4, wherein the displaying at least one of the scheduled and at least one non-scheduled flight information further includes dynamically graphically displaying actual times of the at least one of the scheduled and at least one non-scheduled flight information in parallel with one another along with other portions of a trip, including the dynamically determined travel times of different modes of travel associated with each of the respective at least one of the scheduled and at least one non-scheduled flight information, from door-to-door.

23. The method according to claim 22, wherein the travel times further include airport queue times associated with each of the respective at least one of the scheduled and at least one non-scheduled flight information.

24. The method according to claim 1, further comprising:
receiving a location and reference time at which the traveler is to be at the location;
automatically determining, by the coordination and management computer system, travel information of available transportation that is possible to use that corresponds to the reference time from each of the different transportation systems; and
dynamically generating, by the coordination and management computer system, the consolidated comparative travel booking information report inclusive of available scheduled supply-based air travel options and non-scheduled demand-based air travel options, and ground transportation associated with the respective air travel options.

25. The method according to claim 1, further comprising:
requesting, by the coordination and management computer system, travel-impact information from a travel-impact information system; and
responsive to receiving the travel-impact information, adjusting the travel times of the different modes of travel.

26. The method according to claim 25, wherein requesting travel-impact information from a travel-impact information system includes requesting weather information from the travel-impact information system.

27. The method according to claim 1, further comprising:
dynamically determining, by the coordination and management system, whether a traveler is or will be located at the place and time of departure;
filtering, by the coordination and management system, the non-scheduled demand-based air travel options based on the dynamically determined location or future location of the traveler, thereby limiting the non-scheduled demand-based air travel options that are possibly available to the traveler based on the traveler's current or future location at the place and time of departure; and
transmitting said consolidated comparative travel booking information report with the filtered non-scheduled demand-based air travel options.

28. The method according to claim 27, wherein filtering includes automatically adjusting, by the coordination and management system, the travel request to match the current or future location of the traveler.

29. The method according to claim 1, further comprising:
determining, by the coordination and management system, whether the traveler is a member with restriction rights of other travelers on the non-scheduled demand-based air travel options;
in response to determining that the traveler has restriction rights, filtering any non-scheduled demand-based air travel options on which restricted other passengers currently are booked; and
transmitting said consolidated comparative travel booking information report with the filtered non-scheduled demand-based air travel options.

30. The method according to claim 1, further comprising:
dynamically determining presence, availability, and location of the traveler; and
responsive to determining presence, availability, and location of the traveler, generating, by the coordination and management system, available non-scheduled demand-based air travel options for the traveler.
